(19) United States
(12) Patent Application Publication
(10) Pub. No.: US 2005/0079241 A1
(43) Pub. Date: Apr. 14, 2005

(54) Method and apparatus for molding composite articles

(76) Inventors: John Moore, Holly, MI (US); Steven A Beal, Linden, MI (US)

Correspondence Address: GIFFORD, KRASS, GROH, SPRINKLE & CITKOWSKI, P.C, PO BOX 7021, TROY, MI, 48007-7021, US

(21) Appl. No.: 10/478,663

(22) PCT Filed: May 31, 2002
(86) PCT No.: PCT/US02/17665

Related U.S. Application Data
(60) Provisional application No. 60/294,712, filed on May 31, 2001.
(60) Provisional application No. 60/360,556, filed on Feb. 26, 2002.

(51) Int. Cl. B29C 51/18

(52) U.S. Cl. 425/388; 425/147

(57) ABSTRACT

A method and apparatus for molding composite articles includes a lower frame (14) with a contoured flange, a semi-flexible lower skin (16) and a semi-rigid upper mold half (18). The frame has a contoured flange (24) for drawing a vacuum on a flange (62) of the lower skin. The upper mold half is formed from a skin (20) having a trusswork to make the skin semi-rigid. Pressure sensors (66) are mounted in the mold cavity to sense pressure change of the vacuum with respect to ambient and to control the injection rate of the resin in the cavity.

### FIELD OF THE INVENTION

The present invention relates to a method of molding and molding apparatus for use in the molding of composite articles. More particularly, the invention relates to a method and apparatus for use in resin transfer molding.

### BACKGROUND OF THE INVENTION

Resin transfer molding (RTM) is a process in which dry fiber reinforcement is loaded into a mold cavity. The surfaces of the mold cavity define the ultimate configuration of the article being fabricated. Resin is injected under pressure or drawn under vacuum into the mold cavity to saturate the fiber reinforcement. After the resinated fiber reinforcement is cured, the finished article is removed from the mold.

Recently, RTM molding has been performed in a rigid cavity or lower mold and a skin forming the upper mold. Such a molding process is disclosed in United Kingdom Patent Application 2,319,205A. The flexible upper mold skin is typically made from a composite material. The upper skin is formed over an inverted male mold pattern. Then, a calibration layer of sheet wax defining the mold cavity is laid over the upper skin and a bolster skin is formed over the calibration layer. The exposed face of the bolster skin is shrouded with a frame. The pattern is separated and the calibration layer is removed. The upper skin is then used as part of the upper mold half. However, the skin has a short life expectancy and new skins can be replaced only by reapplying the sheet wax and rebuilding the tipper skin from a calibrated wax surface. This requires the tooling to be out of production for a lengthy period of time depending upon the size of the mold. Additionally, the flow of resin occasionally backs up as it is blown through the fiber reinforcement in the mold cavity, thereby causing an outward deformation of the skin and loss of tolerance in the article being formed.

### BRIEF DESCRIPTIONS OF THE INVENTION

The invention is directed to a novel molding apparatus, a method of forming the apparatus, and a method of using the apparatus to form a composite article. The apparatus includes a semi-flexible skin supported on a lower frame and a semi-rigid upper mold half. The lower frame includes a peripheral flange which surrounds an opening for receiving the cavity of the lower skin. The flange has a contour which is formed to mirror the corresponding structure of the skin. A vacuum is used to draw the lower skin tightly against the flange of the frame and an inner peripheral edge of the flange. The upper mold is formed by applying calibration sheet wax within the cavity of the lower skin. A suitable tooling surface material is applied to the sheet wax followed by a casting of additional materials to form the upper mold half. The skin is then structurally supported by building a trusswork across the back side of the skin to make the upper mold half semi-rigid. A peripheral flange with vacuum ports is formed similar to the flange on the frame to permit a vacuum to be drawn to draw the upper mold tightly against the lower skin. Deflection sensors are mounted to the back sides of the upper and lower skins. The sensors are connected to a CPU to stop or slow the flow of resin if the resin pressure builds to deform the skins.

### BRIEF DESCRIPTION OF THE DRAWING

The invention will now be explained in further detail with reference to the embodiments shown in the drawings in which:

FIG. 1 is a partial sectional view and schematic of the molding apparatus in accordance with the invention;

FIG. 2 is a perspective view of the frame and flange for the lower mold half in accordance with the invention;

FIG. 3 is a cross-sectional exploded view of the upper and lower mold halves;

FIG. 4A is a cross-sectional view of the upper and lower mold halves of the apparatus in accordance with the invention;

FIG. 4B is a partial cross-sectional view of the upper mold half in accordance with the invention;

FIG. 5 is a cross-sectional view of a mechanical sensor in accordance with the invention; and

FIG. 6 is a flowchart showing methods of forming the apparatus in accordance with the invention.

### DETAILED DESCRIPTION OF THE PREFERRED EMBODIMENTS

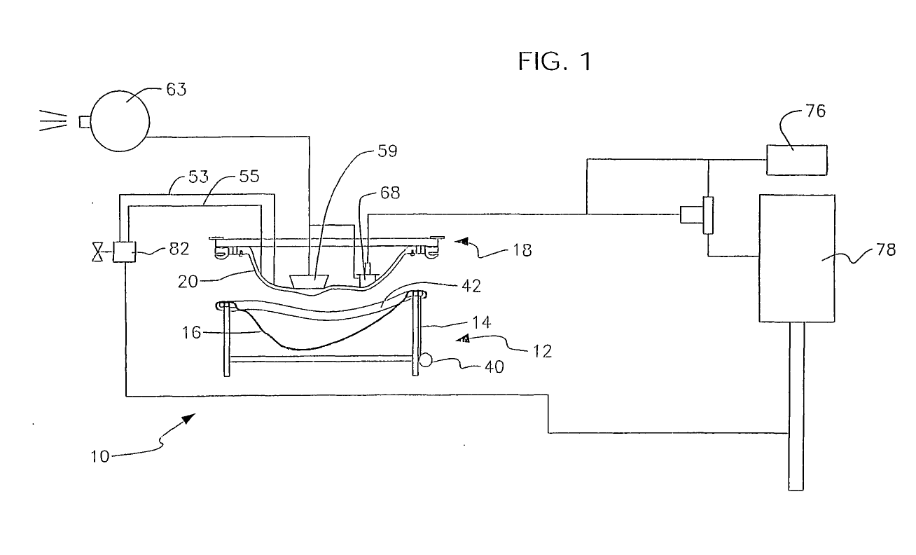

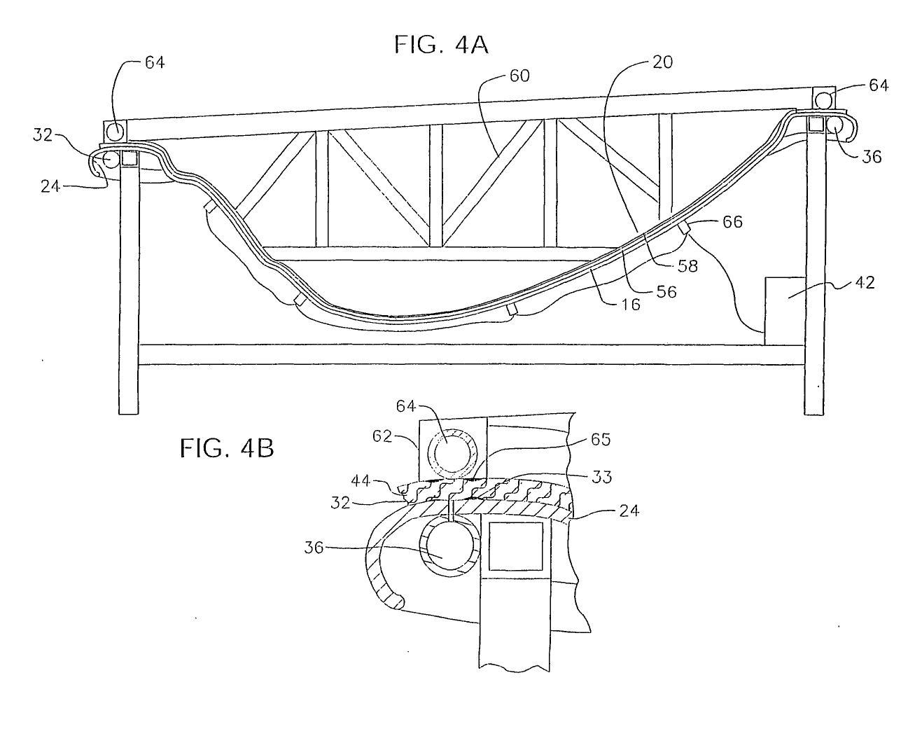

As shown in FIG. 1, an apparatus 10 for resin transfer molding (RTM) includes a lower mold half 12 having a frame 14, a lower cavity skin 16, and an upper mold half 18 having a semi-rigid mold skin 20. The skins of the apparatus 10 form a cavity 22 (FIG. 4A or plenum for molding an article of composite material.

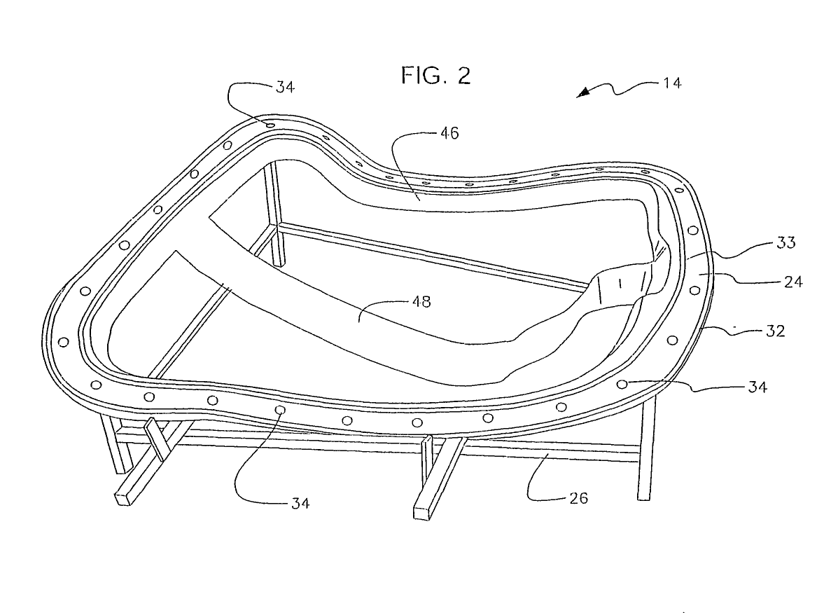

As shown in FIGS. 2, 3 and 4, the lower flame 14 includes a support flange 24 supported on a tubular base 26. The flange 24 is formed to extend peripherally around a cavity portion 28 of tire lower skin 16 (FIG. 4). The support flange 24 has a top surface 30 which is contoured to match a peripheral flange 44 of the cavity skin 16. A pair of spaced apart seals 32, 33 or rubber gaskets extend longitudinally along the top surface 32. A plurality of openings 34 for drawing a vacuum are positioned between the seals 32, 33 and extend through the support flange 24 to a manifold 36 formed on an underside of the flange 24. The manifold 36 is connected by a conduit 38 to a vacuum pump 40 and control unit 42. When the pump 40 is activated, the peripheral flange 44 is drawn against the support flange 24 and the skin is drawn tightly against an inner edge 46 of the support flange 24 to provide rigidity to the skin 16. The inner edge 46 is formed to nest securely against the skin 16. The support flange 24 is formed by band lay-up on the back side of the skin 16. The seals are installed and then resinated cloth is laid on to form a mirror image of the back side of the flange of the skin. Depending upon the size of the article being molded, it may be necessary to provide a composite form 48 extending under a center of the cavity skin 16. The form 48 acts like a sling to support a middle portion of the cavity skin 16.

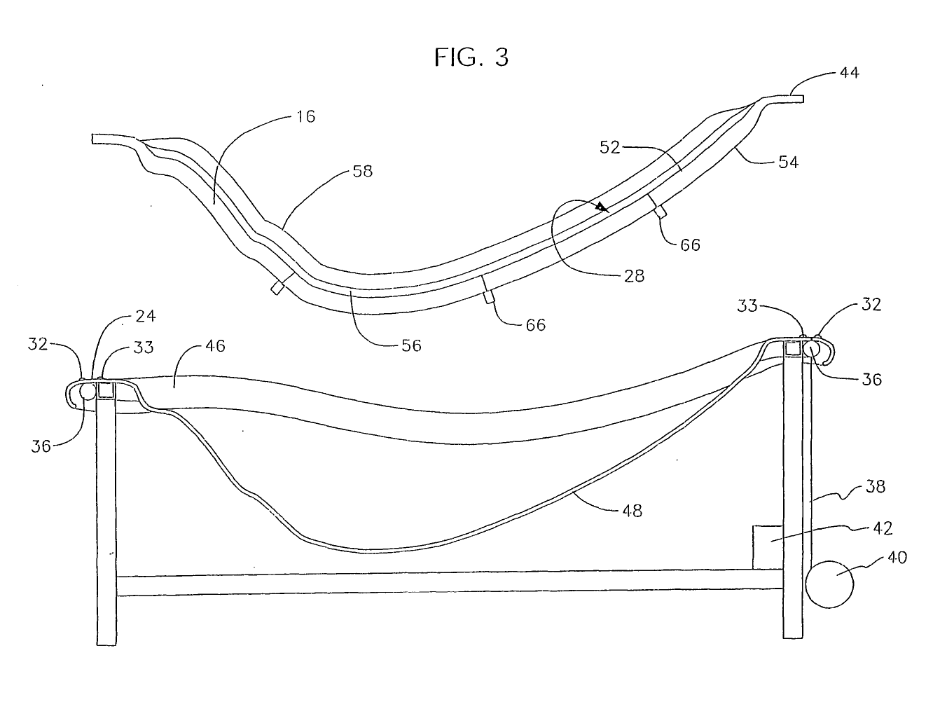

As shown in FIG. 3 the cavity skin 14 is formed with the perimeter flange 44 extending outwardly from the cavity portion 28. The skin 16 has a front side 52 and a back side 54. The front side 52 of the cavity portion 50 has the shape of one side of the article to be formed. The cavity skin 16 is formed on a male mold pattern 56 by a suitable manner such as hand lay-up, vacuum bagging, vacuum form thermoset or thermoplastic sheet. The mold pattern has the shape of the article being formed. The front side 52 of the skin 16 is formed on the pattern. The mold also forms the flange. A pair of gaskets are placed on the portion of the mold forming the flange to form recesses on the flange of the skin to receive seals 32 of the frame as discussed below.

In most applications the molded article will have an outer layer of gel coat. In such applications, the gel coat 56 is applied to the front side of the cavity portion 28 of the skin. Once the gel coat 56 has cured on the cavity portion 28, reinforcement fibers 60 are then fitted to the cavity form. The reinforcement fibers 58 may be fiberglass, aramid, carbon or synthetic fibers which are laid on the gel coat 56 in the cavity portion 28 of the skin. After the skin 16 has been fitted with the reinforcement fibers 58, the skin is placed on the frame with the underside of the peripheral flange 44 of the skin resting on the support flange 24 of the frame. The inner edge 46 of the support flange 24 of the frame 14 extends around the back side of the cavity skin 16 where the cavity portion 28 begins. When a vacuum is drawn, the cavity skin 16 is locked onto the flame 14 and the support flange 24 provides the skin with great rigidity.

As shown in FIGS. 4A and 4B, the upper mold half 18 includes an upper skin 20 which is backed by a truss frame 60 having a flange 62 containing another set of vacuum seals 64, 65. The skin is formed in the same manner as described in GB 2,319,205 A. The truss frame 60 extends across a back side 62 of the skin 20 to make the skin semi-rigid. The frame 60 may be formed of a suitable rigid material such as metal and is permanently affixed by resin to the skin. The frame 60 houses a vacuum manifold 64 which extends about the flange 62 of the upper skin. The manifold 64 is connected to the pump 40. Seals 63, 65 are mounted to the flange 62. The upper mold half 18 and lower mold half 12 have registry guides such as a dowel as known in the art to maintain the upper and lower mold halves 18, 12 in proper position. After the upper mold half 18 is placed over the cavity skin 24, a vacuum is drawn on the upper half to lock the upper mold half on the front side of the cavity skin flange.

As shown in FIG. 1, a vacuum is created in the cavity through a port in the center of the upper mold half 18 from either a catchpot 59 mounted directly on the top of the port or through a tube feeding to a resin trap as is known in the art. After the mold halves have been installed and registered, a vacuum on the flange of the lower skin is drawn by pump 63. Then, a vacuum on the cavity is drawn, typically 0.5 bar, and resin is injected from a supply of resin 51 through ports 53, 55.

As shown in FIG. 4A, pressure sensors, such as a pressure transducer 66, are mounted to both the back sides of the upper and lower mold skins for detecting the pressure within the cavity. The sensor may be pressure transducer 66 or a mechanical valve 68 (FIG. 1) which reacts to a change in pressure. The pressure transducer 66 has a probe which passes through the skin into the cavity. The pressure transducer is able to detect small changes in pressure of 0.1 bar or less. A suitable pressure transducer is produced by Micron Instruments of Simi Valley, Calif. The pressure in the cavity is less than the ambient pressure surrounding the skins. The CPU receives the signals from the sensors, and if there is a positive gain in pressure, the CPU operates a valve to slow or stop the flow of resin before there is a deflection of the skins. When one or more of the sensors sense an increase of pressure at too high a rate or above a threshold pressure, the CPU acts to reduce or stop the flow of resin.

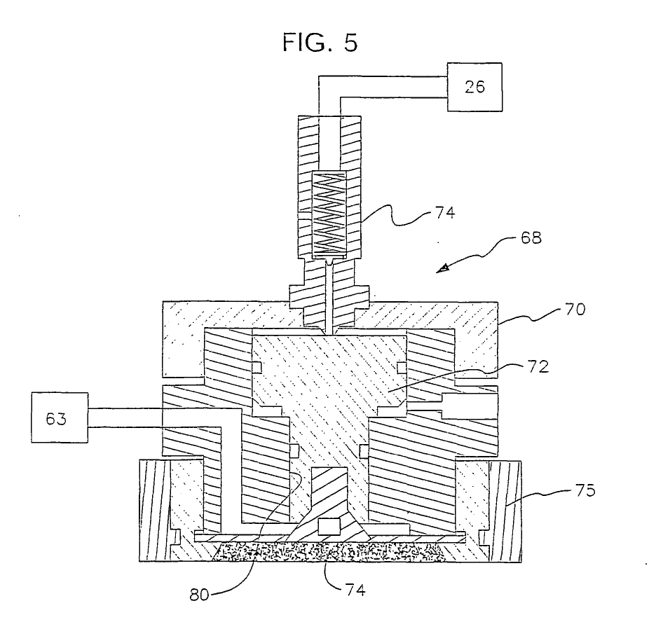

As shown in FIG. 5, the pressure sensor may be a mechanical valve 68 having a housing 70 and a piston 72. A cavity pressure diaphragm 74 is mounted on one end of the piston 72. The housing is mounted to the skin by mold insert ring 75 to be in direct contact with the cavity. One surface of the piston 72 is in a chamber 73 which is connected to the vacuum source 63. A pilot poppet 74 is mounted opposite the piston 72. The pilot poppet 74 is connected to the pump power air supply 76 for a resin pump 78. The pilot poppet 74 is in a normally closed position providing control for the power supply air flowing to the pump 78. The piston 72 is movable through the chamber 73 to close the poppet 74.

When the cavity 22 is placed under vacuum, the pressure is exactly the same in both the cavity 22 and the vacuum connection port which is directly connected to the vacuum source 63 drawing central vacuum. Since the pressure is the same on the cavity diaphragm 74 and in the chamber 73, the piston will remain in a neutral state in which the piston 72 is not in contact with the pilot poppet 74. If the pressure in the cavity 22 increases over the vacuum source pressure, the piston 72 will move to open the pilot poppet 74. Once the piston 72 is lifted from its neutral position, the pilot poppet will release the air holding the pneumatically powered resin pump supply line open.

In an alternative embodiment of the pressure control apparatus, the piston is spring biased against the pressure diaphragm. When the inner mold cavity pressure is eater than the biasing force of the spring, the piston will move to trigger the pilot poppet as above. The sensitivity of the system using this valve is limited to the biasing resistance of the spring. In the previous embodiment, where the vacuum pressure is applied to one side of the valve, minimal changes in mold cavity pressure will result in movement of the piston to trigger the poppet.

When the leak signal is lost, a signal is sent to sever the resin pump from its power supply air and the resin pressure intensified by the resin pump is immediately lost. This allows the cavity pressure to become negative again and the piston then returns to the normal position opening the poppet. The leak signal then is restored and the resin pump power supply is restored to allow the pump to again begin pumping. This operation continues in a “closed loop” until the mold cavity is filled.

As shown in FIG. 1, the valve 68 or sensor 66 may be used with molds having multiple injection ports 53, 55. The injection ports 53, 55 are spaced successively inwardly from the perimeter of the mold towards the center exit vent 56. Resin is injected in the outermost injection points first. When the valve 68 senses a positive increase of cavity pressure, pilot pressure is sent to a diversion valve 90 to close the initial perimeter injection point and to open a succeeding inner injection point(s) to further the resin flow to the center while maintaining a negative cavity pressure. The injection may also be accomplished by using the electronic sensors 66 and CPU to control the flow.

After the injection is complete, the mold is held with the vacuum on the vacuum frame holding the cavity mold and upper mold to maintain closure of the mold halves until the resin cures within the mold cavity. After the prescribed cure time has elapsed, the upper mold half is lifted off the cavity and the molded product is removed.

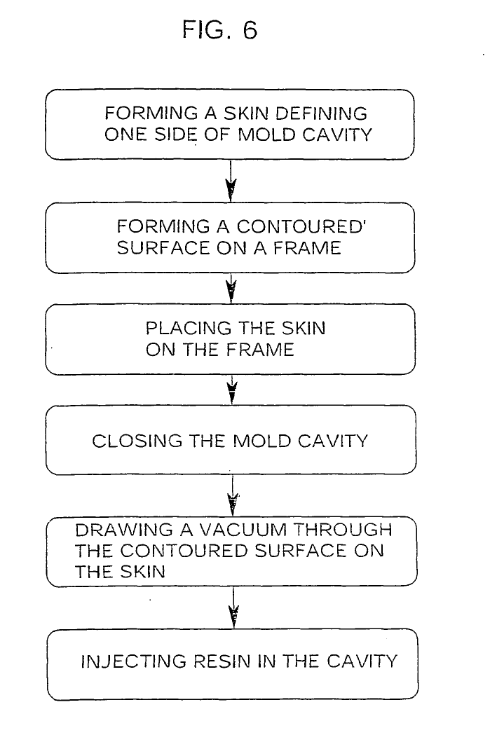

As set forth in FIG. 6 in greater detail with respect to the description of the apparatus, the method includes forming a semi-flexible skin on a male mold pattern for use in defining a cavity for a lower mold half. A contoured flange for supporting the skin on a frame is then formed. The flange has the contour and an inner surface to mate with the back side of a flange. A next step is forming a semi-rigid upper mold half. The semi-rigid mold half may be formed by laying calibration wax over the mold pattern and casting the skin on the calibration wax. A trusswork frame with a vacuum manifold on a flange is mounted to the back of the upper skin. The next step is to place the lower skin onto the flange of the frame and to place the upper mold half on top of the lower skin. A vacuum is drawn through the contoured surface of the lower skin and through the outer flange of the upper mold half to close the mold halves. Finally, resin is injected into the cavity.

Additionally, a method of controlling the injection of the resin includes mounting a pressure sensor in a portion of the cavity, generating signals indicative of the pressure at intervals during the injection process, noting the rate of change of the pressure within the cavity, and controlling injection of resin into the cavity in response to pressure sensed by the sensors.

Thus disclosed is an apparatus and method for RTM molding which is less expensive than conventional methods. The cavity of the mold can be easily replaced at a fraction of the cost of conventional tooling methods. The cavity can be duplicated at minimal expense, thus multiple cavity skins may be used each simultaneously. A gel coat and reinforcement fiber can be applied while other skins are molding products in the mold flames and the shin can be replaced without having to remove the mating half from production.

1. A mold for molding an article by resin transfer molding, said mold comprising:
a lower mold half having a frame and a semi-flexible skin, said frame having a flange for supporting said skin, said frame further having a manifold connected to a plurality of apertures formed in said flange;
a vacuum pump connected to said manifold for drawing a vacuum through said apertures on a back side of said skin; and
an upper mold half having a surface spaced apart from a front side surface of said skin to form a mold cavity for forming said article.

2. The mold half of claim 1 further having at least one pressure sensor extending through said skin into said cavity for sensing the pressure within the cavity and a controller for controlling the flow of resin in said cavity in response to pressure sensed in said cavity.

3. The mold of claim 1 wherein said upper mold half comprises a skin and a trusswork mounted to a back side of said skin.

4. The mold of claim 2 wherein said flange of said flame has a contoured surface adapted to conform to said back side of a portion of said skin.

5. The mold of claim 4 wherein said flange has an inner peripheral edge formed to nest against a back side of a portion of said skin.

6. An apparatus for molding an article comprising:
at least one skin having a back side and a front side, said front side defining a portion of a mold cavity;
a pressure sensor mounted to a back side of said skin and having a portion extending through said skin into said cavity, said sensor generating a signal indicative of pressure in said cavity; and
a control unit for controlling the injection of resin into said cavity in response to said signal generated by said sensor.

7. The apparatus of claim 6 wherein said sensor is a pressure transducer.

8. The apparatus of claim 6 wherein said sensor is a valve having a membrane mounted in said cavity.

9. A method of molding an article, said method comprising the steps of:
forming a skin having a peripheral flange extending around a mold cavity;
placing said skin in a lower frame;
placing an upper mold having a flange on the upper surface of said flange of said skin;
drawing a vacuum through said lower frame on a back side surface of said flange of said skin and drawing a vacuum through said upper mold on an upper surface of said flange of said skin; and
drawing resin through a plenum formed between said skin and said upper mold to form the article.

10. The method of claim 9 further comprising drawing a back side peripheral portion of said cavity against a peripheral edge of said frame to provide rigidity to said skin.

11. The method of claim 9 further comprising forming said upper mold from a semi-flexible skin and forming a framework on a back side of said skin to provide rigidity to said mold.

12. A method of controlling a molding process comprising the steps of:
mounting a sensor on a deformable skin defining a portion of a mold cavity;
injecting resin into said cavity;
sensing deformation of said skin with said sensor;
generating a signal indicative of deformation; and
controlling the flow of resin in response to said signal.
